(19) United States
(12) Patent Application Publication
(10) Pub. No.: US 2010/0236419 A1
(43) Pub. Date: Sep. 23, 2010

(54) DISPENSING DEVICE FOR LOOSE PRODUCTS FOR THE PREPARATION OF BEVERAGES, AND MACHINE CONTAINING SAID DISPENSING DEVICE

(76) Inventors: Marco Righetti, Bologna (IT); Marco Talini, Bologna (IT)

Correspondence Address: MCGLEW & TUTTLE, PC, P.O. BOX 9227, SCARBOROUGH STATION, SCARBOROUGH, NY, 10510-9227, US

(21) Appl. No.: 12/377,951

(22) PCT Filed: Sep. 4, 2007
(86) PCT No.: PCT/IT2007/000610

§ 371 Date: Feb. 18, 2009

(30) Foreign Application Priority Data
Sep. 8, 2006 (IT) FI2006A000222

(51) Int. Cl. A47J 31/40; G01F 11/24

(52) U.S. Cl. 99/289 R; 222/368

(57) ABSTRACT

The dispenser comprises a hopper (1) to contain the loose product (P), and an screw feeder (7) to feed the loose product from the hopper towards a dispensing opening (25). Positioned in the dispensing opening is a shut-off valve (27), which closes the dispensing opening. The screw feeder feeds the loose product towards the valve and movement of the valve causes delivery of the loose product from the cells.

### TECHNICAL FIELD

The present invention relates to a dispenser to dispense loose products, in particular although not exclusively, powdered products and preferably, although not exclusively, freeze-dried powdered products for the preparation of beverages or other substantially liquid edible products.

State of the Art

To prepare beverages, such as coffee, tea and also broth or other liquid or substantially liquid edible products, loose powdered products, normally freeze-dried, are frequently used, which are dispensed in predetermined doses from a dispenser towards an area in which the beverage is prepared inside a dispensing machine, normally a vending machine.

The loose product, for instance in powder, is contained in a hopper at the base of which is a screw feeder which, rotating, feeds a quantity of powdered or other loose product towards a dispensing opening, from which the powder is dispensed to a unit for preparation of the beverage by adding hot water. See WO-A-2006/079580.

IT-B-1093232 describes a machine for automatic dispensing hot beverages using freeze-dried powders, wherein the freeze-dried powder is dispensed by means of a rotating cylinder positioned inside a seat provided in the base of a hopper. The rotating cylinder has a series of cells of predetermined dimensions, so that rotation of said cylinder for a specific number of turns or fractions of turn allows a predefined dose of the powdered product to be dispensed towards a conduit into which hot water also flows, with a metering system.

These prior art devices have considerable drawbacks due to the presence of steam coming from the area in which the beverage is prepared, directly below the dispensing opening of the freeze-dried powder or other loose product. The steam raises towards the area of the dispensing opening of the freeze-dried powder. The latter, being hygroscopic, absorbs the water that condenses and forms lumps of powder, which results in malfunctioning and clogging of the dispensing device and shut-down of the machine. Moreover, the device illustrated in the Italian patent IT-B-1093232 has the drawback that the steam which condenses on the rotating cylinder is transferred directly inside the hopper of the freeze-dried powders due to rotation of the metering cylinder.

In many machines, it is also necessary to dispense additional products besides the basic products for preparation of the beverage or other edible product. For example and typically (although not exclusively), it may be necessary to dispense dosable quantities of sugar, sweeteners or other substances.

U.S. Pat. No. 3,710,991 discloses a fluent material dispenser including a container for a fluent material and an auger for feeding said fluent material towards an aperture. A sliding closure member is provided, which keeps the outlet aperture closed. A first motor controls the motion of the auger and a second motor controls the movement of the sliding closure member. When a certain amount of material shall be dispensed, the first motor is energized and opens the sliding closure member. A cam is arranged on the motor shaft of the second motor and a follower is combined to said cam. The cam-follower arrangement causes the first motor to be energized once the sliding closure member has been brought into the open position. This known device does not provide a satisfactory barrier against moisture during dispensing of the material.

Other loose material dispenser devices specifically designed for beverage preparing machines are disclosed in EP-A-848925; U.S. Pat. No. 4,572,060; EP-A-1176402; EP-A-331271.

DE-A-10312013 discloses a granular material dispensing device which is designed to dispense fluent material from a container in a gaseous flow for transportation. The device includes an auger and, in an intermediate position along the axial development of the auger, a rotating valve. The rotating valve and the auger are independently motorized by means of separate electric motors, each of which is controlled by means of specific electronic control devices.

### OBJECT AND SUMMARY OF THE INVENTION

An object of the present invention is to produce a dispensing device that overcomes entirely or in part the drawbacks of prior art devices.

In substance, according to the invention, a dispenser is provided wherein a screw feeder is positioned in the base of a hopper containing the loose product to feed the loose product towards a dispensing opening. Moreover, contrary to what occurs in conventional dispensing devices, the dispensing opening is not free, which would cause the steam to raise and condense in the areas in which the freeze-dried powder or other product, such as sugar or the like, is present, but positioned therein is a valve, defining at least one cell, which closes the dispensing opening to prevent steam from raising therein and thus prevent the formation of lumps of freeze-dried powder or other loose product contained in the dispenser, and also moves to dispense the product towards the area in which the beverage or the like is prepared. The screw feeder is produced and positioned to feed the loose product to the cell or cells of the valve. The moving valve can be a slide valve, with one or more cells. Nonetheless, the valve is preferably a rotary valve with one or preferably a plurality of cells.

Besides preventing steam from raising towards the loose product and in general entry of humidity, also atmospheric (particularly useful in the case of freeze-dried powders), the moving valve can attain further advantages such as: preventing the accidental feed of product caused by movements of the hopper and to vibrations; prevent or reduce exposure of the loose product to external agents and the penetration, for instance of insects, thereby ensuring increased hygiene.

Advantageously, when the valve is a rotary valve, rotation of the valve and of the screw feeder are controlled with a ratio determined so that the volume of loose product fed by the screw feeder substantially precisely fills the cells of the rotating valve, thereby obtaining efficient metering of the powdered product.

The valve can be configured in any way, and in particular with a rotating body and cells distributed along the circumferential extension of the body. However, according to an advantageous embodiment, the valve is designed as a blade valve, i.e. with a central body and radial blades defining, between consecutive pairs of blades, respective cells for the loose product.

Housing of the rotary valve in the dispensing opening in substance makes it possible to define a moving barrier which on the one hand allows the loose product dispensed by the screw feeder to be delivered towards the area in which the beverage is dispensed and on the other prevents steam from raising towards the area in which the loose product is contained.

In an advantageous embodiment, the valve rotates about an axis, which is substantially parallel to the rotation axis of the screw feeder and the two elements can be advantageously connected to each other by a mechanical transmission member, such as a pair of gears. However, it would also be possible for each of the two elements (screw feeder and rotary valve) to be equipped with a respective motor. Nonetheless, by providing members to transmit motion from one to the other of the two elements it is possible to produce a less expensive dispenser, equipped with a single motor for both screw feeder rotation and valve rotation. Preferably, the motor is connected to the screw feeder shaft, directly or indirectly through a kinematic transmission, and the screw feeder in turn transmits motion to the rotary valve. In an advantageous embodiment, the mechanical transmission between screw feeder and valve is such that the rotation speed of the screw feeder is lower than the rotation speed of the valve.

According to a possible embodiment, the valve is positioned in a housing, which has a cross section for the entry of the loose product towards the cells of the valve which is greater than the cross section for delivery of the loose product, thereby obtaining an improved barrier effect against the raising of steam towards the screw feeder.

The invention also relates to a machine for the preparation of beverages or the like using loose products, in particular freeze-dried products or the like, and hot water, comprising a dispenser of the type described.

Further advantageous characteristics of the device according to the invention will be described hereunder with reference to a possible embodiment of the invention.

### BRIEF DESCRIPTION OF THE DRAWINGS

The present invention will be better understood by following the description and accompanying drawing, which shows a non-limiting practical embodiment of the invention. More specifically:

FIG. 1 shows a section according to a median vertical plane of the hopper with the screw feeder and the dispensing opening containing the distribution valve;

FIG. 2 shows an axonometric view of the open dispensing opening, with the valve housed therein;

FIG. 3 shows an axonometric view of the screw feeder, of the block containing the dispensing opening and of the gear transmission between the screw feeder and the rotary valve.

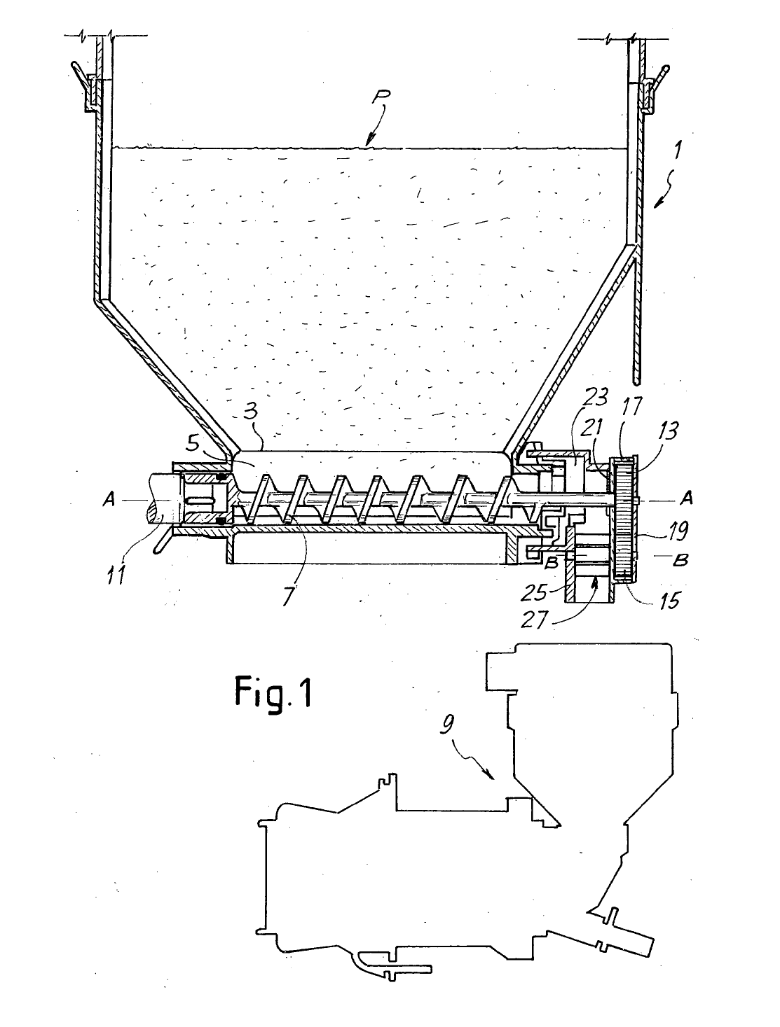

### DETAILED DESCRIPTION OF AN EMBODIMENT OF THE INVENTION

A detailed description of an embodiment of the invention will be provided here below, with a rotary valve in the form of blade valve. Although this configuration has particular advantages and is currently preferable, other embodiments of the invention are possible, such as with a slide valve, i.e. provided with an alternative movement and equipped, for instance, with only one cell or also with several cells to receive the product to be dispensed.

In the drawing, the numeral 1 indicates a hopper containing a loose product, such as a freeze-dried powder, sugar or the like, indicated with P. The base of the hopper has an opening 3 towards a compartment 5, positioned inside which is a screw feeder 7 rotating about an axis A-A which, when the dispensing device 1 is installed in a machine to prepare beverages, can be in a substantially horizontal position.

Positioned under the dispenser 1 is a unit 9 to prepare beverages by mixing the product P dispensed by the device 1 in water. The parts of the machine to prepare the beverage in which the actual preparation of the beverage takes place are not of interest herein and are known per se and consequently will not be illustrated and described in further detail.

The screw feeder 7 is operated by a motor 11 positioned at one end thereof, while at the opposite end the shaft 7A of the screw feeder is equipped with a first gear 13 meshing with a second gear 15 below. The two gears 13, 15 are housed in a chamber 17 frontally closed by a cover 19 and separated by means of a diaphragm 21 from a compartment 23, into which the loose product P is pushed by the screw feeder 7, and from a dispensing opening 25 below. Positioned in the dispensing opening 25 is a rotary valve 27 on the shaft of which a gear wheel 15 is keyed.

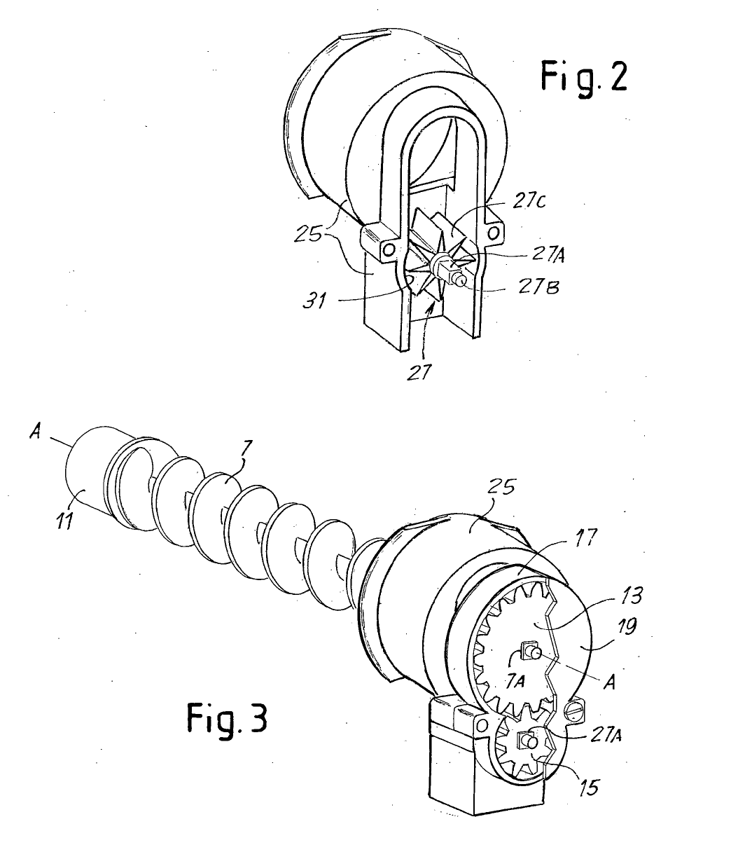

As can be seen in particular in FIG. 2, the valve 27 is in substance a blade valve, which has a main body 27A produced in one piece with the shaft 27B onto which the gear wheel 15 is keyed. The valve 27 is housed inside a seat 31, which has a substantially rectangular inlet cross section of greater dimensions in relation to the outlet cross section, under the valve 27. This difference in section is produced, in this embodiment, through suitably shaping the sidewall defining the dispensing opening 25. It would also be possible for the inlet and outlet sections to be produced with the same shape and dimension.

As is understood from the description above, rotation of the motor 11 causes rotation of the screw feeder 7 about the axis A-A thereof and, as a consequence of transmission through the gears 13, 15, rotation of the metering valve 27 about the axis B-B thereof, substantially parallel to the axis A-A. As the diameter of the gear 13 is greater than that of the gear 15, the rotation speed of the valve 27 will be greater than the rotation speed of the screw feeder 7.

The screw feeder rotates to dispense towards the dispensing opening 25 a dose of loose product P determined by the number of turns or fractions of turn implemented by the screw feeder 7 each time it is operated. This product is delivered through the dispensing opening 25 by controlled rotation of the rotary valve 27 towards the area 9 in which the beverage is prepared. The radial blades 27C which project from the central body or central core 27A of the valve 27 define compartments to receive the loose product and dispense it towards the opening 25. The blades 27C close the cross section of the dispensing opening 25, so that humidity cannot penetrate therethrough towards the area containing the loose product P. Any steam that condenses on the blades 27C is in very small quantities and in any case does not concern the content of the hopper 1, but remains limited inside the area of the dispensing opening 25.

It is understood that the drawing only shows an example of embodiment of the invention, which can vary in forms and arrangements without however departing from the scope of the concept underlying the invention. Any reference numerals in the appended claims are provided to facilitate reading of the claims with reference to the description and to the drawing, and do not in any way limit the scope of protection.

1. A dispenser of loose products for the preparation of beverages or the like, comprising:
a hopper to contain the loose product; and
a screw feeder to feed the loose product from said hopper towards a dispensing opening, wherein positioned in said dispensing opening is a shut-off valve, which closes said dispensing opening, the screw feeder being arranged to feed the loose product towards said valve, said valve being a rotary valve including at least one cell to receive a dose of loose product, the rotation of said valve causing delivery of the loose product, said screw feeder and said valve being mechanically connected with motion transmission members such that said valve rotates along with said screw feeder.

2. A dispenser as claimed in claim 1, wherein said valve comprises a plurality of cells.

3. A dispenser as claimed in claim 1, wherein said valve is a blade valve, respective cells being defined between pairs of consecutive blades.

4. A dispenser as claimed in claim 1, wherein said valve rotates about an axis substantially parallel to the axis of rotation of the screw feeder.

5. A dispenser as claimed in claim 1, wherein said screw feeder is motorized and wherein a single motor controls the rotation of said screw feeder and said valve.

6. A dispenser as claimed in claim 5, wherein said screw feeder and said valve are connected by means of a gear transmission.

7. A dispenser as claimed in claim 1, wherein the rotation speed of the screw feeder is below the rotation speed of the valve.

8. A dispenser as claimed in claim 1, wherein said valve is positioned in a housing which has an inlet cross section for the loose product towards the cells of the valve which is greater than the outlet cross section.

9. A dispenser as claimed in claim 1, wherein said screw feeder ends in a compartment where said loose product is fed by said screw feeder, said rotating valve being arranged underneath said compartment.

10. A dispenser as claimed in claim 9, wherein the screw feeder has a shaft extending through said compartment into a chamber, wherein said motion transmission members are arranged.

11. (canceled)

12. A machine for the preparation of beverages or the like using loose products, comprising:
a dispenser comprising:
at least one hopper to contain a loose product; and
a screw feeder to feed the loose product from said hopper towards a dispensing opening, wherein positioned in said dispensing opening is a shut-off valve, which closes said dispensing opening, the screw feeder being arranged to feed the loose product towards said valve, said valve being a rotary valve including at least one cell to receive a dose of loose product, the rotation of said valve causing delivery of the loose product, said screw feeder and said valve being mechanically connected with motion transmission members such that said valve rotates along with said screw feeder.

13. A dispenser as claimed in claim 2, wherein said valve is a blade valve, respective cells being defined between pairs of consecutive blades.

14. A dispenser as claimed in claim 2, wherein said valve rotates about an axis substantially parallel to the axis of rotation of the screw feeder.

15. A dispenser as claimed in claim 2, wherein said screw feeder is motorized and wherein a single motor controls the rotation of said screw feeder and said valve.

16. A dispenser as claimed in claim 15, wherein said screw feeder and said valve are connected by means of a gear transmission.

17. A beverage dispensing machine, comprising:
a dispenser comprising:
a hopper to contain the loose product; and
a screw feeder to feed the loose product from said hopper towards a dispensing opening, wherein positioned in said dispensing opening is a shut-off valve, which closes said dispensing opening, the screw feeder being arranged to feed the loose product towards said valve, said valve being a rotary valve including at least one cell to receive a dose of loose product, the rotation of said valve causing delivery of the loose product, said screw feeder and said valve being mechanically connected with motion transmission members such that said valve rotates along with said screw feeder.
